(19) United States
(12) Patent Application Publication
(10) Pub. No.: US 2019/0111529 A1
(43) Pub. Date: Apr. 18, 2019

(54) Planetary Repair Tool

(71) Applicant: Robert A. Newville, Cameron, WI (US)

(72) Inventor: Robert A. Newville, Cameron, WI (US)

(21) Appl. No.: 15/977,073

(22) Filed: May 11, 2018

Related U.S. Application Data
(60) Provisional application No. 62/573,317, filed on Oct. 17, 2017.

(51) Int. Cl. B23P 6/02; F16H 57/00; B21J 15/02

(52) U.S. Cl. CPC B23P 6/02; F16H 2057/0062; B21J 15/02; F16H 57/00

(57) ABSTRACT

A tool for removing and replacing a piston from a drum of an automotive transmission has a generally circular base including a first set of openings arranged, when the tool is placed on a drum of an automotive transmission, to be in alignment with rivets attaching the piston to the drum. A cutting element is inserted into each of the first set of openings for cutting the rivets to remove the piston from the drum for repair or replacement. A second set of openings in the base are offset from the first set of openings when the tool is placed on the drum. A drilling element is inserted into each of the second set of openings for drilling holes in the drum which are offset from the first set of openings for readily removably mounting the repaired or replacement piston to the drum at positions on the drum offset from the positions at which the rivets have been cut. A method for removing and replacing the piston from the drum is provided by use of the tool.

The present patent application claims the benefit of United States Provisional Patent Application No. 62/573,317, filed on Oct. 17, 2017.

### BACKGROUND OF THE INVENTION

The present invention is generally directed to a tool, method and system for modifying an automotive transmission, to facilitate removal of a piston from a drum. The system is particularly, but not exclusively, adapted for use in connection with an automatic automotive transmission of the “ZF8HP” series currently installed in certain BMW vehicles.

In the “factory installed” ZF8HP automotive transmission, the piston is nonremovably attached to the drum by rivets, rendering it difficult to remove the piston from the drum for inspection, repair and replacement purposes, thereby increasing the time, labor, and expense involved in repairing and replacing the piston.

The present invention provides a tool, method and system for modifying a “factory installed” automotive transmission, including a ZF8HP automotive transmission in which a piston is non removably mounted to a drum, to readily remove and replace the piston from the drum.

### SUMMARY OF THE INVENTION

A tool includes a generally circular base including a first set of a plurality of openings arranged, when the tool is placed on a drum of an automotive transmission, to be in alignment with rivets attaching a piston to the drum. A cutting element is insertable into each of the first set of openings for cutting the rivets to remove the piston from the drum for repair or replacement. A second set of plurality of openings defined in the base are offset from the first set of openings when the tool is placed on the drum. A drilling element is insertable into each of the second set of openings for drilling holes in the drum which are offset from the first set of openings for mounting the repaired or replacement piston to the drum.

### BRIEF DESCRIPTION OF THE DRAWINGS

FIG. 1 of the drawing illustrates an exploded view of a first embodiment of the present invention;

FIG. 2 illustrates an exploded view of a second embodiment of the present invention;

FIG. 3 illustrates another view of the tool in accordance with the second embodiment of the invention; and

FIG. 4 illustrates a drum of an automotive transmission after it has been modified in accordance with the present invention.

### DESCRIPTION OF THE BEST MODES FOR CARRYING OUT THE INVENTION

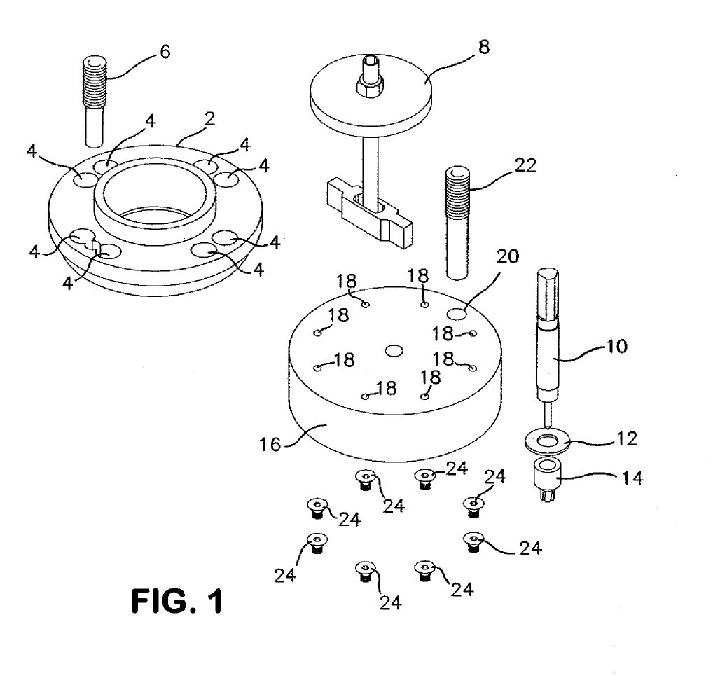

FIG. 1 of the drawing illustrate the tool, method and system in accordance with a first embodiment of the present invention. FIG. 1 is an exploded view of the tool and its components for modifying the “factory installed” ZF8HP automotive transmission in accordance with the system and method of the present invention.

A removal tool designated by reference numeral 2 defines a plurality of peripheral openings designated by reference numeral 4. The openings 4 are arranged to be in alignment with the position of rivets attaching the piston to the drum of the automotive transmission when the removal tool is placed in the drum. A locator pin designated by reference numeral 6 is insertable through the openings 4 in the removal tool 2.

The removal tool 2 is placed in the drum, and the locator pin 6 is inserted into one of the openings 4. The removal tool is then rotated in the drum until the locator pin is aligned with the position of one of the rivets attaching the piston to the drum. In this position, each opening 4 will be aligned with a different one of the rivets attaching the piston to the drum so that all openings 4 are aligned with all rivets, respectively. When the removal tool 2 is in this aligned position relative to the drum, a clamping assembly, designated by reference numeral 8, is provided to secure the removal tool to the drum.

An arbor designated by reference numeral 10, together with a washer designated by reference numeral 12 and a cutting element designated by reference numeral 14, are inserted through the openings 4 in the removal tool 2 to cut the rivets attaching the piston to the drum. When all rivets are cut, the removal tool 2 and the piston are removed from the drum.

A drill tool designated by reference numeral 16 is then placed into the drum. The drill tool has a plurality of peripheral openings designated by reference 18, and a larger peripheral opening designated by reference numeral 20. The openings 18 are arranged to be offset from the positions of the cut rivets on the drum. An opening 20 is arranged so that it can be moved into alignment with one of the position of one of the cut rivets on the drum.

The drill tool is placed in the drum, and a locator pin designated by reference numeral 22 is inserted through one opening 20 in the drill tool. The drill tool is then rotated relative to the drum until the locator pin and the one opening 20 are aligned with one position on the drum where a rivet has been cut. In this position of the drill tool relative to the drum, all openings 18 in the drill tool are offset from each position on the drum in which a rivet has been cut. The clamping assembly 8 is then provided to secure the drill tool to the drum, and a tap and drill (not shown in the drawing) is provided to drill holes in the drum through each of the openings 18. Since the openings 18 in this relative position of the drill tool and the drum are offset from the positions on the drum where the cut rivets are located, the holes drilled in the drum through the openings 18 are separated and away from the areas on the drum where the cut rivets are located.

The piston is then placed into the drum, and removably secured in the drum by screws 24 inserted into the new offset openings drilled in the drum. The piston can now be readily removed from the drum simply by unscrewing the screws 24, and readily replaced in the drum simply by screwing it back into the drum. Thus, the piston can easily be removed from, and replaced on, the drum for inspection, repair and/or replacement by simply unscrewing and screwing the piston from and to the drum, thereby saving substantial time, labor and costs in connection with an inspection, repair or replacement.

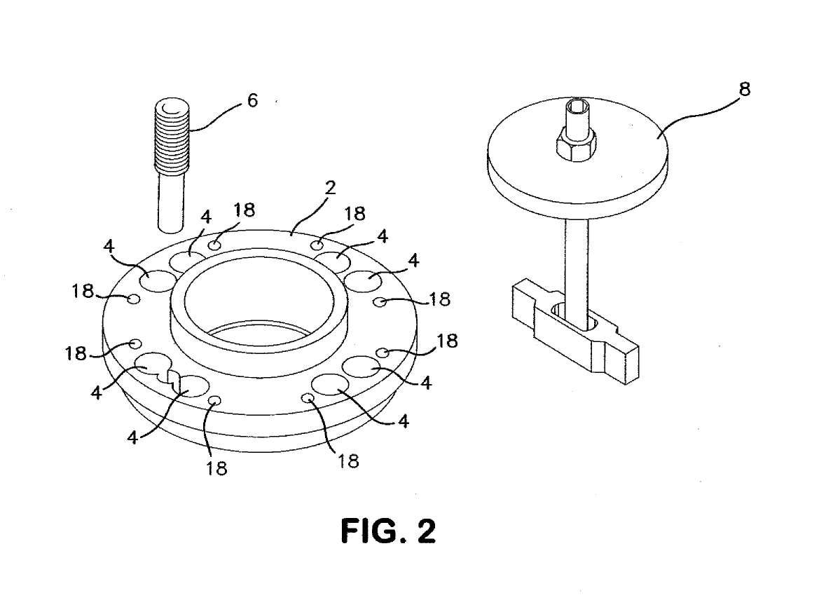

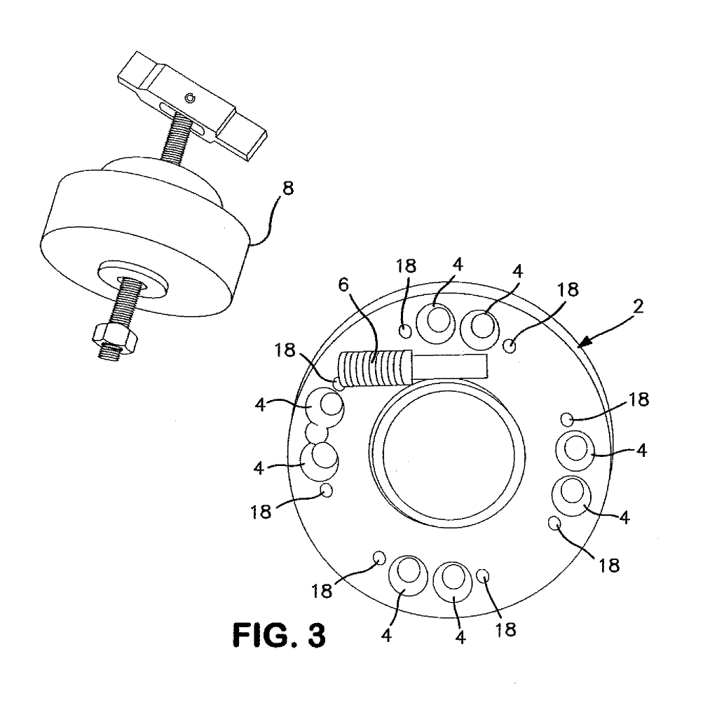

FIGS. 2-3 illustrate the components of the tool, method and system in accordance with a second embodiment of the present invention.

The second embodiment illustrated by FIGS. 2-3 is similar to the first embodiment illustrated by FIG. 1 and the same components are designated by the same reference numerals. Unlike the embodiment illustrated by FIG. 1, the FIGS. 2-3 embodiment eliminates the drill tool designated by reference numeral 16, and the arbor 10, the washer 12 and the cutting element 12, associated with the drill tool 16. Instead, the smaller openings 18 defined in the drill tool 16 of FIG. 1 are now defined directly in the removal tool 2, offset from the larger openings 4. In this manner, a single component, the removal tool 2, is employed to both remove the rivets attaching the drum to the piston, and also drill the holes in the drum for removably connecting the drum to the piston by the screws 24. This is accomplished by providing the first set of openings 4, which are aligned with the rivets to be cut to remove the piston from the drum, and the second set of openings 18, which are offset from the first set of openings and provide guides for drilling new holes in the drum, on the same component.

The second embodiment of the invention illustrated by FIGS. 2-3 thus eliminates several components required to perform the method of the first embodiment of the invention, and eliminates the intermediate step of drilling the smaller openings 18 separately from removing the rivets by the removal tool 2 since removing of the rivets and drilling the smaller openings is done using a single tool in a single step.

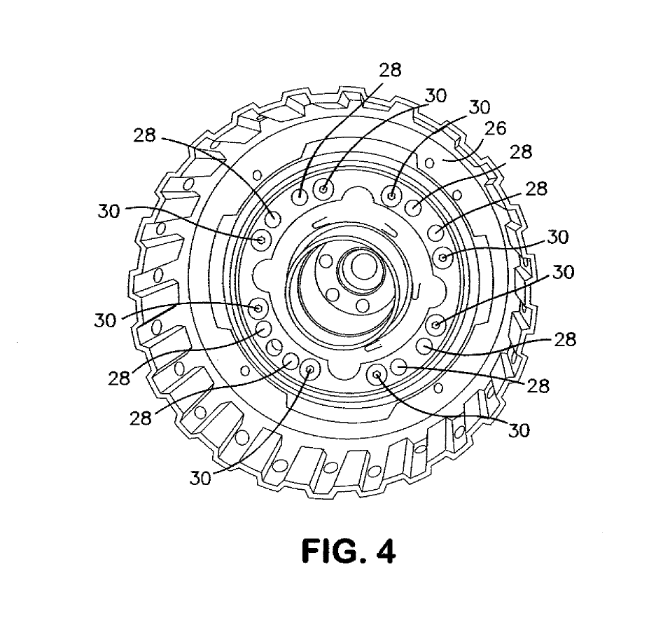

FIG. 4 illustrates a drum 26 after it has been modified in accordance with the present invention. Reference numeral 28 illustrates the positions of the cut rivets on the drum, namely, the positions the at which the rivets had attached the piston to the drum in the “factory installed” automotive transmission. As discussed above, the rivets in the “factory installed” transmission have been cut in accordance with the present invention.

Reference numeral 30 illustrates the positions on the drum at which the new openings for receiving the screws 24 have been drilled in accordance with the present invention. As a result of the tools, method, and system described herein, each of the new openings 30 drilled into the drum are offset and separated from the positions 28 of the cut rivets on the drum 26.

As is apparent from the above discussion and as illustrated by the drawings, the present invention provides components specifically designed and arranged to correspond to the positions of the rivets in the drum of the “factory installed” transmission, and to drill new holes in the drum of the “factory installed” transmission at locations which are offset from the cut rivets, thereby modifying the “factory installed” transmission to enable quick and easy removal of the piston from the drum for inspection, repair or replacement, and to enable quick and easy replacement of the piston in the drum.

1. A tool for removing and replacing a piston from a drum in an automotive transmission, said tool comprising a generally circular base comprising a first set of a plurality of openings defined therein and spaced apart from each other in a first predetermined arrangement, said base comprising a second set of a plurality of openings defined therein and spaced apart from each other and from said first set of plurality of openings in a second predetermined arrangement.

2. The tool as claimed in claim 1, wherein said first predetermined arrangement of said first set of plurality of openings to correspond to the position of rivets attaching a piston to a drum in said automotive transmission.

3. The tool as claimed in claim 1, wherein said second predetermined arrangement of said second set of plurality of openings are offset from said first predetermined arrangement of said first set of plurality of openings.

4. The tool as claimed in claim 1, wherein said first predetermined arrangement of said first set of plurality of openings corresponds to the position of rivets attaching a piston to a drum in said automotive transmission, and said second predetermined arrangement of said second set of plurality of openings are offset from the first predetermined arrangement of said first set of plurality of openings.

5. The tool as claimed in claim 1, wherein said first set of plurality of openings are adapted to receive a cutting element for cutting rivets attaching a piston to a drum in said automotive transmission.

6. The tool as claimed in claim 1, wherein said second set of plurality of openings are adapted to receive a drilling element for drilling openings in a drum of said automotive transmission for attaching a piston to said drum.

7. The tool as claimed in claim 1, wherein said automotive transmission is a ZF8HP.

8. A method for removing and replacing a piston from a drum in an automotive transmission, said method comprising the steps of:
providing a tool comprising a generally circular base comprising a first set of a plurality of openings defined therein and spaced apart from each other in a first predetermined arrangement, said base comprising a second set of a plurality of openings defined therein and spaced apart from each other and from said first set of plurality of openings in a second predetermined arrangement;
placing said tool over said drum of said automotive transmission such that said first set of plurality of openings is aligned with rivets attaching the piston to the drum;
inserting a cutting element through each of said first set of plurality of openings for cutting said rivets attaching said piston to said drum; and
inserting a drilling element through each of said second set of plurality of openings for drilling openings in said drum which are offset from said first set of plurality of openings.

9. The method as claimed in claim 9, wherein said automotive transmission is a ZF8HP.

10. The method as claimed in claim 9, including the step of attaching a replacement piston to said drum by rivets inserted through said second set of plurality of openings drilled into said drum.

11. A tool for removing and replacing a piston from a drum in an automotive transmission, said tool comprising a first tool component having a generally circular base comprising a first set of a plurality of openings defined therein and spaced apart from each other in a first predetermined arrangement, and a second tool component comprising a second set of a plurality of openings defined therein and spaced apart from each other and from said first set of plurality of openings in a second predetermined arrangement.

12. The tool as claimed in claim 11, wherein said first predetermined arrangement of said first set of plurality of openings to correspond to the position of rivets attaching a piston to a drum in said automotive transmission.

13. The tool as claimed in claim 11, wherein said second predetermined arrangement of said second set of plurality of openings are offset from the first predetermined arrangement of said first set of plurality of openings.

14. The tool as claimed in claim 11, wherein said first predetermined arrangement of said first set of plurality of openings to correspond to the position of rivets attaching a piston to a drum in said automotive transmission, and said second predetermined arrangement of said second set of plurality of openings are offset from the first predetermined arrangement of said first set of plurality of openings.

15. The tool as claimed in claim 11, wherein said first set of plurality of openings are adapted to receive a cutting element for cutting rivets attaching a piston to a drum in said automotive transmission.

16. The tool as claimed in claim 11, wherein said second set of plurality of openings are adapted to receive a drilling element for drilling openings in a drum of said automotive transmission for attaching a piston to said drum.

17. The tool as claimed in claim 11, wherein said automotive transmission is a ZF8HP.

18. A method for removing and replacing a piston from a drum in an automotive transmission, said method comprising the steps of:
providing a tool comprising a first tool component having a generally circular base comprising a first set of a plurality of openings defined therein and spaced apart from each other in a first predetermined arrangement, and a second tool component comprising a second set of a plurality of openings defined therein and spaced apart from each other and from said first set of plurality of openings in a second predetermined arrangement;
placing said first component of said tool over said drum of said automotive transmission such that said first set of plurality of openings is aligned with rivets attaching the piston to the drum;
inserting a cutting element through each of said first set of plurality of openings for cutting said rivets attaching said piston to said drum; and
placing said second component of said tool over said drum of said automotive transmission such that said second set of plurality of openings is offset from said first set of plurality of openings; and
inserting a drilling element through each of said second set of plurality of openings for drilling openings in said drum which are offset from said first set of plurality of openings.

19. The method as claimed in claim 19, wherein said automotive transmission is a ZF8HP.

20. The method as claimed in claim 19, including the step of attaching a replacement piston to said drum by rivets inserted through said second set of plurality of openings drilled into said drum.
